(19) United States
(12) Patent Application Publication
(10) Pub. No.: US 2025/0364941 A1
(43) Pub. Date: Nov. 27, 2025

(54) Solar Tree Device

(71) Applicant: Kelly Miyashiro, Kapolei, HI (US)

(72) Inventor: Kelly Miyashiro, Kapolei, HI (US)

(21) Appl. No.: 19/296,336

(22) Filed: Aug. 11, 2025

Related U.S. Application Data
(63) Continuation-in-part of application No. 18/149,291, filed on Jan. 3, 2023.
(60) Provisional application No. 63/426,188, filed on Nov. 17, 2022.

(51) Int. Cl. H02S 20/20; H02J 3/38; H02S 10/12; H02S 30/20

(52) U.S. Cl. CPC H02S 20/20; H02J 3/38; H02S 10/12; H02S 30/20; H02J 2300/24; H02J 2300/28; H02J 2300/40

(57) ABSTRACT

A novel solar tree device is disclosed. The device is a photovoltaic configuration along a pole component. The device comprises a pole component with multiple solar panels secured along its length via connector components. The connector components are positioned all along the length and around the circumference of the pole component, similar to branches on a tree. Generally, the device can accommodate 30 or more solar panels in a small space to generate supplemental power to electrical systems, electric vehicles, etc. The solar panels are positioned on the pole component, such that they are angled 10 to 15 degrees toward the sun for maximum power generation, depending on the height of the pole component. Thus, the device offers off-the-grid charging.

### CROSS-REFERENCE TO RELATED APPLICATION

The present application is a continuation-in-part application of U.S. patent application Ser. No. 18/149,291 which was filed on Jan. 3, 2023 and claims priority to and the benefit of U.S. Provisional Application No. 63/426,188 which was filed on Nov. 17, 2022, both of which are incorporated herein by reference in their entirety.

### FIELD OF THE INVENTION

The present invention relates generally to the field of solar tree devices. More specifically, the present invention relates to an improved solar tree device that provides users with a solar panel tower that can accommodate multiple solar panels on a central pole. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in solar tree devices. Generally, fossil fuels are dangerous to the environment and solar panels are an option for some people to obtain renewable electricity. Standard solar panels are large and bulky making it difficult to find space to install. People may want to purchase solar panels but lack the space to do so.

Further, renewable, high-efficiency, and cost-effective sources of energy are becoming a growing need on a global scale. Increasingly expensive, unreliable, and environmentally risky fossil fuels and a rising global demand for energy, including electricity, have created the need for alternate, secure, clean, widely available, cost-effective, environmentally friendly, and renewable forms of energy. Thus, the use of solar panels has become a popular option due to the obvious environmental benefits of solar energy.

Accordingly, it is desired to improve the overall configuration of multiple solar panels, such that they can be used as a renewable source of energy. The invention described herein contemplates a multi-tiered structure that results in a more efficient utilization of space and may also utilize and harness thermal energy radiated from the sun more efficiently.

Therefore, there exists a long-felt need in the art for a solar tree device that provides users with a solar panel tower that can accommodate 30 or more solar panels on a central pole. There is also a long-felt need in the art for a solar tree device that resembles a tree such that the solar panels can surround the central pole like branches. Further, there is a long-felt need in the art for a solar tree device that accommodates more solar panels in a smaller space compared to a standard solar power generation system. Moreover, there is a long-felt need in the art for a device that functions in commercial and residential environments for supplying power to various electronics, such as generators, electric vehicles, etc. Further, there is a long-felt need in the art for a solar tree device that encompasses different heights and amounts of solar panels. Finally, there is a long-felt need in the art for a solar tree device that offers off-the-grid charging.

The subject matter disclosed and claimed herein, in one embodiment thereof, comprises a solar tree device. The device is a photovoltaic configuration along a pole component. The device comprises a pole component with multiple solar panels secured along its length via connector components. The connector components are positioned all along the length and around the circumference of the pole component, similar to branches on a tree. Generally, the device can accommodate 30 or more solar panels in a small space to generate supplemental power to electrical systems, electric vehicles, etc. The solar panels are positioned on the pole component, such that they are angled 10 to 15 degrees toward the sun for maximum power generation, depending on the height of the pole component. Thus, the device offers off-the-grid charging.

In this manner, the solar tree device of the present invention accomplishes all of the foregoing objectives and provides users with a device that accommodates multiple solar panels in a small space. The device generates supplemental power for various electrical systems. The device can be configured in different heights and diameters based on a user's preferences.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar tree device. The device is a photovoltaic configuration along a pole component. The device comprises a pole component with multiple solar panels secured along its length via connector components. The connector components are positioned all along the length and around the circumference of the pole component, similar to branches on a tree.

In one embodiment, the solar tree device comprises a plurality of solar panels secured to a pole component for generating electricity from sunlight. Such solar panels are disposed concentrically around the pole component and secured like tree branches, so as to form a tree-shaped solar panel configuration. Further, the vertical pole component may be mounted in the ground or to a base.

In one embodiment, the pole component is mounted vertically on a base. The base may house one or more batteries electrically connected to one or more solar panels of the device for storing the electrical energy captured via the solar panels. The base may further house an inverter for converting DC energy produced by the device into AC energy that is usable by conventional electric systems of a building or power grid.

In one embodiment, the pole component comprises an internal cavity. However, the pole component may be solid without any internal cavity as well. In the present embodiment, the internal cavity may be useful for arranging wires, and the shape and size of the internal cavity may be determined according to the material used to form the pole component, so as to maintain the strength of the pole component. In the embodiment where the pole component is mounted in the ground, the internal cavity can be used to house the one or more batteries electrically connected to the solar panels, as well as the inverter for converting DC energy into AC energy, and any other suitable components deemed necessary.

Further, the pole component can be made with one or more materials. For example, such materials include metal, such as aluminum and stainless steel, ceramics, concrete, resin, such as plastic resin or vinyl resin, plastic, composite material, wood, wood composite, glass, rubber, carbon, etc., and combinations thereof. The base can be made with one or more materials, such as, for example, metal, ceramic, concrete, resin, plastic, composite material, wood, wood composite, glass, rubber, carbon, etc. Additionally, the pole component of the device may be formed through processes such as extrusion, molding, assembling, and cutting. If the pole component is formed of concrete, the concrete typically includes cement placed in a mold together with reinforcing materials such as steel reinforcing bars, wires, and wire meshes. If the pole component is formed of wood, the pole component may be treated with a waterproof agent for waterproofing and insect proofing as well.

In one embodiment, the solar tree device can have varying proportions and installation of the device may vary to fit different standards or preferences, as desired. Further, the base and its internal components, can be disposed in the ground or underground to conserve a footprint of the device. Further, the pole component may be of varying height and/or may include a varying number of solar panels. Typically, there are at least 30 solar panels disposed on the pole component, however any suitable number of solar panels can be utilized as is known in the art, depending on the needs and/or wants of a user. Thus, the device can accommodate 30 or more solar panels in a small space to generate supplemental power to electrical systems, electric vehicles, etc.

In one embodiment, the pole component may be a length selected according to the amount of solar panels required for use. In addition, the length of the pole component may be determined depending on the strength of the material of the pole component. Thus, the pole component can be manufactured in a predetermined length and thickness so that the pole component can be installed in a structurally stable state capable of resisting strong wind and not too thin or thick to form a visually balanced tree-shaped solar tree device. Specifically, the size of the diameter of the pole component may be determined according to the sizes of the solar panels. That is, the pole component may be sized according to the sizes of the solar panels available in the market. Additionally, the length of the pole component may be determined according to the number of solar panels used. That is, the length of the pole component can be determined based on the number of solar panels to be assembled on the pole component.

Further, the pole component is oriented vertically or substantially vertically relative to the ground. Each pole component comprises an arrangement of multiple individual solar panels which are supported by one or more connector components or structures attached to the pole component. The connector components/structures may support multiple solar panels as a unified assembly, or each solar panel may be supported by a separate corresponding connector component/structure. Further, the connector components may also electrically connect the solar panels to the internal electrical system of the device for transferring electricity to the battery and other components.

In one embodiment, the connector components are secured to the pole component to attach the solar panels. Since the connector components are vertically held and fixed to the outside of the pole component like a branch, the solar panel can be positioned upwardly, horizontal, or downwardly according to the assembling angle required. In one embodiment, the solar panels are secured in an approximately 10 to 15 degree angle relative to the sun for maximum power generation. Generally, the angle required for maximum power generation depends on the height of the pole component, as well as the position of the other solar panels secured above and below on the pole component. Therefore, the solar panels attached to the pole component can be adjusted upward, horizontal, or downward.

In one embodiment, the solar panels located toward the top of the pole component are generally smaller relative to the solar panels located toward the bottom of the pole component, such that the overall shape of the solar tree device is generally conical. Moreover, to allow each solar panel to receive light and impart the tree-like structure, the overall maximum length of each successive solar panel is greater than the preceding solar panel relative to and approaching the ground. The overall maximum length of the solar panel is measured from the length of the solar panel extending radially from the pole component. Generally, it will be understood that the increasing size of each solar panel as they are successively located proximate the ground will impart a triangular cross-sectional shape.

In one embodiment, the device comprises multiple solar panels arranged around the circumference of the pole component, wherein the multiple solar panels each extend radially away from the longitudinal axis of the pole component and slope downward relative to a point of attachment to the pole component. As such, each tier of solar panels may form a generally conical shape.

In one embodiment, the solar panels comprise photovoltaic material for absorbing light energy and heat conducting material. Typically, an outer or upper layer is a photovoltaic material, and an inner or lower layer is a heat conducting surface or the outer or upper layer is a heat conducting surface and an inner or lower layer is a photovoltaic material. Thus, in each solar panel, there is a light-absorbing and reflecting top surface also referred to as a photovoltaic surface, and a heat conducting bottom surface to capture thermal energy; or the solar panel has a light-absorbing and reflecting bottom surface and a heat conducting top surface to capture thermal energy. Further, the radial length of the lower solar panel may be longer than the radial length of the upper solar panel to maximize light capture.

The solar panels may be embodied in various shapes. Embodiments of the claimed invention may utilize flat, conical or convex solar panels. One of ordinary skill in the art will recognize that various types of solar panels, such as those sold by third parties, may be used to implement the claimed invention. Further, the solar panels are well-known parts in the related art, and thus detailed descriptions thereof will not be provided.

In some embodiments, the solar panels include a light reflecting ridge. One or more ridges may be employed on the solar panel to maximize the amount of exposure to sunlight.

Further, the solar panels can be made from a variety of spectrum-specific cells. By dispersing light into various components, the spectrum-specific cells can absorb their own light spectrum easily. One or more light dispersive media may be added to one or more layers.

In one embodiment, the surfaces of the solar panels can comprise transparent glass plates which may be coated with a cleaning agent or uneven texture so that contaminants such as dust can be easily separated by self-cleaning.

In one embodiment, the solar tree device is encapsulated in a clear outer shell to protect the device from the elements. The clear outer shell can be made with one or more materials, but is primarily made with transparent materials, such as, for example, glass, acrylic, resin, composite materials, etc. The outer shell can also include some parts made with non-transparent materials, such as, for example, metal, ceramic, concrete, resin, plastic, composite material, wood, wood composite, glass, rubber, carbon, etc. Such non-transparent materials would form parts used in a frame and frame components that support and stabilize the outer shell.

Accordingly, embodiments of the present invention are variously configured to derive electricity from the solar panels. The output may be supplied over conductors (not shown) to the battery. Electricity from these sources (i.e., solar panels) may be combined for convenience if permitted by the parameters of the generated electricity. In one embodiment, the solar panels generate DC electricity allowing use of a single power conductor to emerge from the solar tree device. The DC electricity is converted to AC electricity in an inverter for direct use by a consumer or for input to an electrical grid. The inverter and associated controls can be located at the base, in the pole component, or in a separate proximate structure.

In yet another embodiment, the solar tree device comprises a plurality of indicia.

In yet another embodiment, a method of efficiently generating solar power in a small space is disclosed. The method includes the steps of providing a solar tree device comprising a pole component with multiple solar panels secured along the length. The method also comprises choosing a specific height and diameter of the pole component. Further, the method comprises securing a predetermined number of solar panels to the pole component. The method comprises placing the device in a predetermined location. Finally, the method comprises generating solar energy to power various electrical systems via the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a close-up perspective view of one embodiment of the solar tree device of the present invention in accordance with the disclosed architecture;

FIG. 2 illustrates a perspective view of one embodiment of the solar tree device of the present invention in use in accordance with the disclosed architecture;

FIG. 3 illustrates a perspective view of one embodiment of the solar tree device of the present invention showing the solar panels attached to the pole component in accordance with the disclosed architecture;

FIG. 4 illustrates a perspective view of one embodiment of the solar tree device of the present invention showing the tree-like configuration in accordance with the disclosed architecture;

FIG. 5 illustrates a perspective view of one embodiment of the solar tree device of the present invention showing a plurality of solar panels in accordance with the disclosed architecture; and

FIG. 6 illustrates a flowchart showing the method of efficiently generating solar power in a small space in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a solar tree device that provides users with a solar panel tower that can accommodate 30 or more solar panels on a central pole. There is also a long-felt need in the art for a solar tree device that resembles a tree such that the solar panels can surround the central pole like branches. Further, there is a long-felt need in the art for a solar tree device that accommodates more solar panels in a smaller space compared to a standard solar power generation system. Moreover, there is a long-felt need in the art for a device that functions in commercial and residential environments for supplying power to various electronics, such as generators, electric vehicles, etc. Further, there is a long-felt need in the art for a solar tree device that encompasses different heights and amounts of solar panels. Finally, there is a long-felt need in the art for a solar tree device that offers off-the-grid charging.

The present invention, in one exemplary embodiment, is a novel solar tree device. The device is a photovoltaic configuration along a pole component. The device comprises a pole component with multiple solar panels secured along its length via connector components. The connector components are positioned all along the length and around the circumference of the pole component, similar to branches on a tree. Generally, the device can accommodate 30 or more solar panels in a small space to generate supplemental power to electrical systems, electric vehicles, etc. The solar panels are positioned on the pole component, such that they are angled 10 to 15-degrees toward the sun for maximum power generation, depending on the height of the pole component. The present invention also includes a novel method of efficiently generating solar power in a small space. The method includes the steps of providing a solar tree device comprising a pole component with multiple solar panels secured along the length. The method also comprises choosing a specific height and diameter of the pole component. Further, the method comprises securing a predetermined number of solar panels to the pole component. The method comprises placing the device in a predetermined location. Finally, the method comprises generating solar energy to power various electrical systems via the device.

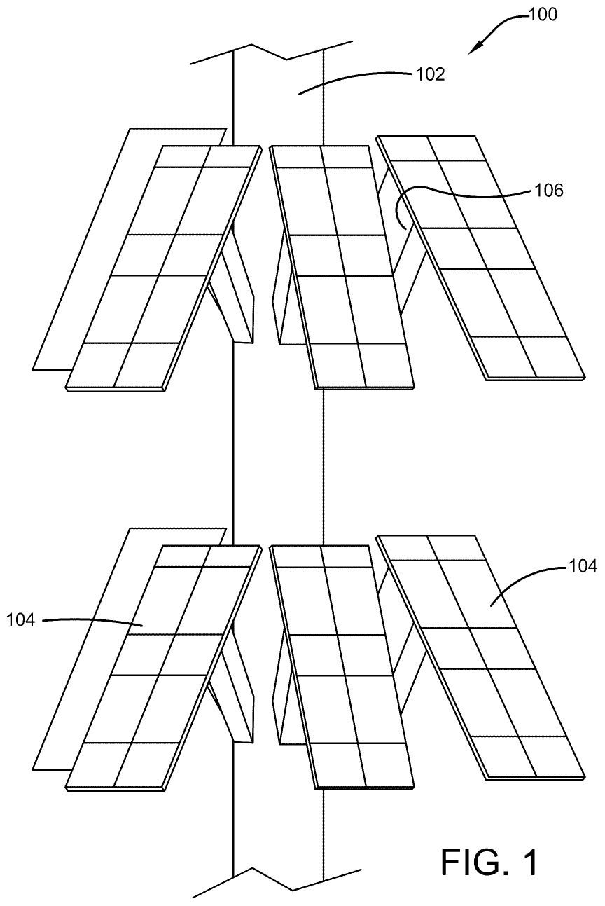

Referring initially to the drawings, FIG. 1 illustrates a perspective view of one embodiment of the solar tree device 100 of the present invention. In the present embodiment, the solar tree device 100 is an improved solar tree device 100 that accommodates more solar panels 104 in smaller spaces. Further, the device 100 is a photovoltaic configuration along a pole component 102. Specifically, the device 100 comprises a pole component 102 with a plurality of solar panels 104 secured via connector components 106 along the length in a tree-like configuration. The connector components 106 are positioned all along the length and around the circumference of the pole component 102, similar to branches on a tree.

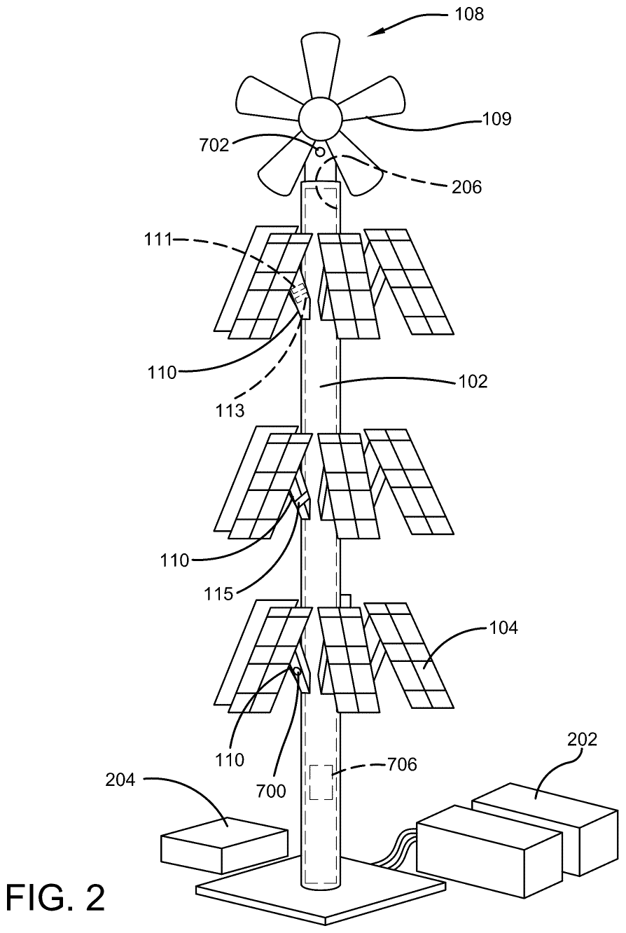

As shown in FIG. 2, the solar tree device 100 comprises a plurality of solar panels 104 secured to a pole component 102 for generating electricity from sunlight. Such solar panels 104 are disposed concentrically around the pole component 102 and secured like tree branches, so as to form a tree-shaped solar panel configuration. Further, the vertical pole component 102 may be mounted in the ground or to a base 200.

In one embodiment, the pole component 102 is mounted vertically on a base 200. The base 200 may house one or more batteries 202 electrically connected to one or more solar panels 104 of the device 100 for storing the electrical energy captured via the solar panels 104. The base 200 may further house an inverter 204 for converting DC energy produced by the device 100 into AC energy that is usable by conventional electric systems of a building or power grid (not shown).

Further, the pole component 102 comprises an internal cavity 206. However, the pole component 102 may be solid without any internal cavity 206 as well. In the present embodiment, the internal cavity 206 may be useful for arranging wires, and the shape and size of the internal cavity 206 may be determined according to the material used to form the pole component 102, so as to maintain the strength of the pole component 102. In the embodiment where the pole component 102 is mounted in the ground, the internal cavity 206 can be used to house the one or more batteries 202 electrically connected to the solar panels 104 as well as the inverter 204 for converting DC energy into AC energy, and any other suitable components deemed necessary as is known in the art.

Further, the pole component 102 can be made with one or more materials. For example, such materials include metal, such as aluminum and stainless steel, ceramics, concrete, resin, such as plastic resin or vinyl resin, plastic, composite material, wood, wood composite, glass, rubber, carbon, etc., and combinations thereof, or any other suitable materials as is known in the art. The base 200 can be made with one or more materials, such as, for example, metal, ceramic, concrete, resin, plastic, composite material, wood, wood composite, glass, rubber, carbon, etc., or any other suitable materials as is known in the art. Additionally, the pole component 102 of the device 100 may be formed through processes such as extrusion, molding, assembling, and cutting, etc. If the pole component 102 is formed of concrete, the concrete typically includes cement placed in a mold together with reinforcing materials such as steel reinforcing bars, wires, and wire meshes. If the pole component 102 is formed of wood, the pole component 102 may be treated with a waterproof agent for waterproofing and insect proofing as well.

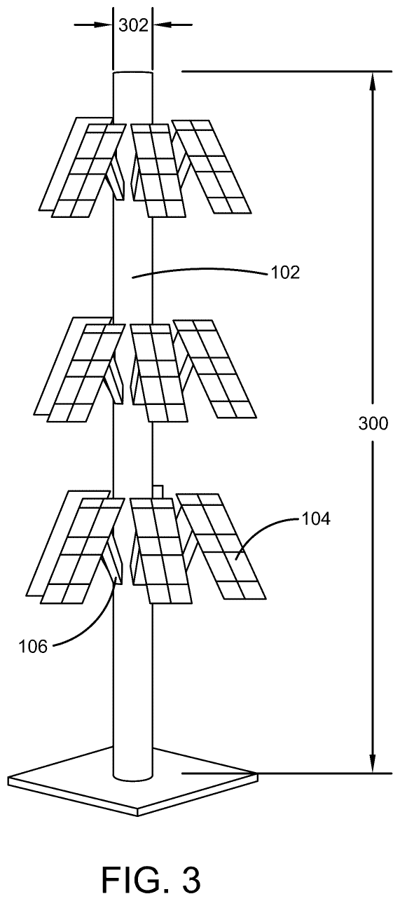

As shown in FIG. 3, the solar tree device 100 can have varying proportions and installation of the device 100 may vary to fit different standards or preferences, as desired. Further, the base 200 and its internal components, can be disposed in the ground or underground to conserve a footprint of the device 100. Further, the pole component 102 may be of varying height and/or may include a varying number of solar panels 104. Typically, there are at least 30 solar panels 104 disposed on the pole component 102, however any suitable number of solar panels 104 can be utilized as is known in the art, depending on the needs and/or wants of a user. Thus, the device 100 can accommodate 30 or more solar panels 104 in a small space to generate supplemental power to electrical systems, electric vehicles, etc.

Further, the pole component 102 may be a length 300 selected according to the amount of solar panels 104 required for use. In addition, the length 300 of the pole component 102 may be determined depending on the strength of the material of the pole component 102. Thus, the pole component 102 can be manufactured in a predetermined length 300 and thickness so that the pole component 102 can be installed in a structurally stable state capable of resisting strong wind and not too thin or thick to form a visually balanced tree-shaped solar tree device 100. Specifically, the size of the diameter 302 of the pole component 102 may be determined according to the sizes of the solar panels 104. That is, the pole component 102 may be sized according to the sizes of the solar panels 104 available in the market. Additionally, the length 300 of the pole component 102 may be determined according to the number of solar panels 104 used. That is, the length 300 of the pole component 102 can be determined based on the number of solar panels 104 to be assembled on the pole component 102.

Further, the pole component 102 is oriented vertically or substantially vertically relative to the ground. Each pole component 102 comprises an arrangement of multiple individual solar panels 104 which are supported by one or more connector components 106 or structures attached to the pole component 102. The connector components/structures 106 may support multiple solar panels 104 as a unified assembly, or each solar panel 104 may be supported by a separate corresponding connector component/structure 106. Further, the connector components 106 may also electrically connect the solar panels 104 to the internal electrical system of the device 100 for transferring electricity to the battery 202 and other components. Any suitable connector component 106 can be utilized as is known in the art, as long as it secures the solar panels 104 to the pole component 102 for use.

Furthermore, the connector components 106 are secured to the pole component 102 to attach the solar panels 104. Since the connector components 106 are vertically held and fixed to the outside of the pole component 102 like a branch, the solar panel 104 can be positioned upward, horizontal, or downward according to the assembling angle required. In one embodiment, the solar panels 104 are secured in an approximately 10 to 15 degree angle relative to the sun for maximum power generation. Generally, the angle required for maximum power generation depends on the height of the pole component 102 as well as the position of the other solar panels 104 secured above and below on the pole component 102. Therefore, the solar panels 104 attached to the pole component 102 can be adjusted upward, horizontal, or downward, as needed.

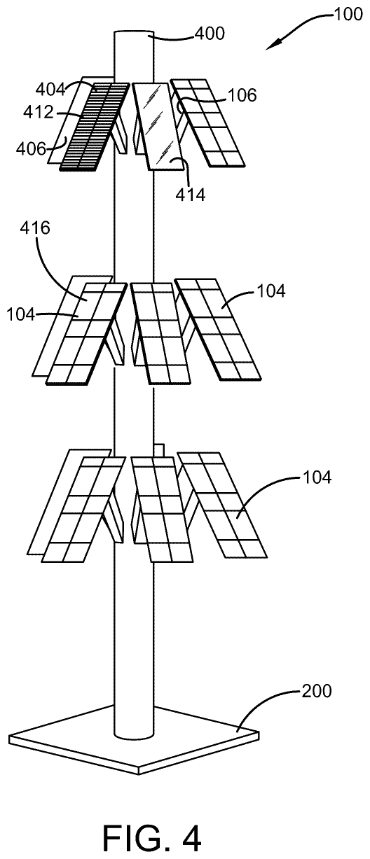

As shown in FIG. 4, the solar panels 104 located toward the top 400 of the pole component 102 are generally smaller relative to the solar panels 104 located toward the bottom 402 of the pole component 102, such that the overall shape of the solar tree device 100 is generally conical. Moreover, to allow each solar panel 104 to receive light and impart the tree-like structure, the overall maximum length of each successive solar panel 104 is greater than the preceding solar panel 104 relative to and approaching the ground. The overall maximum length of the solar panel 104 is measured from the length of the solar panel 104 extending radially from the pole component 102. Generally, it will be understood that the increasing size of each solar panel 104 as they are successively located proximate the ground will impart a triangular cross-sectional shape to the device 100.

Furthermore, the device 100 comprises multiple solar panels 104 arranged around the circumference of the pole component 102, wherein the multiple solar panels 104 each extend radially away from the longitudinal axis of the pole component 102 and slope downward relative to a point of attachment to the pole component 102. As such, each tier of solar panels 104 may form a generally conical shape.

In one embodiment, the solar panels 104 comprise photovoltaic material 404 for absorbing light energy and heat conducting material. Typically, an outer or upper layer 408 is a photovoltaic material layer 404 and an inner or lower layer 410 is a heat conducting surface 406 or the outer or upper layer 408 is a heat conducting surface 406 and an inner or lower layer 410 is a photovoltaic material layer 404. Thus, in each solar panel 104, there is a light-absorbing and reflecting top surface also referred to as a photovoltaic surface 404, and a heat conducting bottom surface 406 to capture thermal energy; or the solar panel 104 has a light-absorbing and reflecting bottom surface 404 and a heat conducting top surface 406 to capture thermal energy. Further, as stated supra, the radial length of the lower solar panel 104 may be longer than the radial length of the upper solar panel 104 to maximize light capture.

Further, the solar panels 104 may be embodied in various shapes. Embodiments of the claimed invention may utilize flat, conical or convex solar panels 104. One of ordinary skill in the art will recognize that various types of solar panels 104, such as those sold by third parties, may be used to implement the claimed invention. Further, the solar panels 104 are well-known parts in the related art, and thus detailed descriptions thereof will not be provided.

In some embodiments, the solar panels 104 include a light reflecting ridge 412. One or more ridges 412 may be employed on the solar panel 104 to maximize the amount of exposure to sunlight, depending on the wants and/or needs of a user.

Further, the solar panels 104 can be made from a variety of spectrum-specific cells. By dispersing light into various components, the spectrum-specific cells can absorb their own light spectrum easily. One or more light dispersive media may be added to one or more layers of the solar panels 104.

In one embodiment, the surfaces 414 of the solar panels 104 can comprise transparent glass plates 416 which may be coated with a cleaning agent or uneven texture, so that contaminants, such as dust, can be easily separated by self-cleaning.

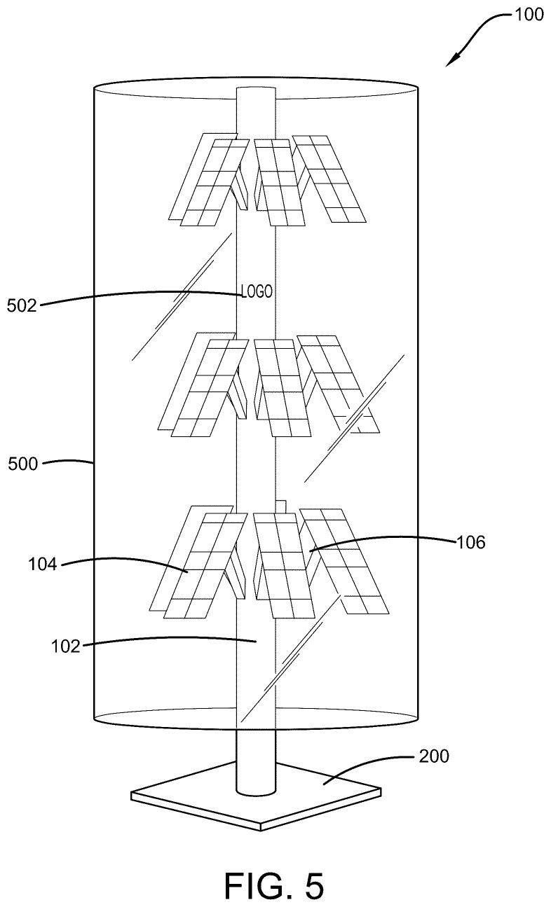

As shown in FIG. 5, the solar tree device 100 is encapsulated in a clear outer shell 500 to protect the device 100 from the elements. The clear outer shell 500 can be made with one or more materials, but is primarily made with transparent materials, such as, for example, glass, acrylic, resin, composite materials, etc. The outer shell 500 can also include some parts made with non-transparent materials, such as, for example, metal, ceramic, concrete, resin, plastic, composite material, wood, wood composite, glass, rubber, carbon, etc. Such non-transparent materials would form parts used in a frame and frame components that support and stabilize the outer shell 500.

Accordingly, embodiments of the present invention are variously configured to derive electricity from the solar panels 104. The output may be supplied over conductors (not shown) to the battery 202. Electricity from these sources (i.e., solar panels 104) may be combined for convenience if permitted by the parameters of the generated electricity. In one embodiment, the solar panels 104 generate DC electricity allowing use of a single power conductor to emerge from the solar tree device 100. The DC electricity is converted to AC electricity in an inverter 204 for direct use by a consumer or for input to an electrical grid. The inverter 204 and associated controls can be located at the base 200, in the pole component 102, or in a separate proximate structure.

Furthermore, the solar tree device 100 comprises a plurality of indicia 502. The pole component 102 of the device 100 may include advertising, trademark, or other letters, designs, or characters, printed, painted, stamped, or integrated into the pole component 102, or any other indicia 502 as is known in the art. Specifically, any suitable indicia 502 as is known in the art can be included, such as, but not limited to, patterns, logos, emblems, images, symbols, designs, letters, words, characters, animals, advertisements, brands, etc., that may or may not be solar panel or brand related.

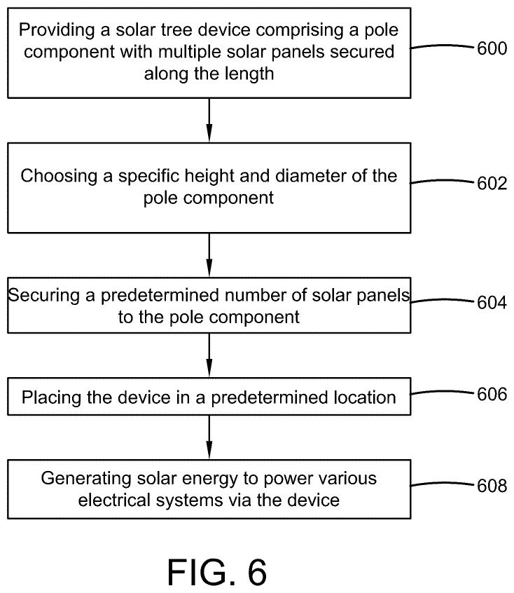

FIG. 6 illustrates a flowchart of the method of efficiently generating solar power in a small space. The method includes the steps of at 600, providing a solar tree device comprising a pole component with multiple solar panels secured along the length via a retractable mounting assembly comprised of a retraction mechanism. The method also comprises at 602, choosing a specific height and diameter of the pole component. Further, the method comprises at 604, securing a predetermined number of solar panels to the pole component. The method comprises at 606, placing the device in a predetermined location. Finally, the method comprises at 608, generating solar energy to power various electrical systems via the device.

In one embodiment, the solar tree device 100 may further comprise at least one wind turbine 108 mounted on the pole component 102. The wind turbine 108 may include one or more rotor blades 109 of any type, style and configuration that are configured to rotate in response to wind flow, thereby generating electrical energy from wind power. The wind turbine 108 may be electrically connected to the inverter 204 and the battery 202 for integration with the solar power system, enabling hybrid energy generation through both solar and wind resources. The rotor blades 109 may be comprised of materials such as but not limited to any combination of fiberglass, carbon fiber, aluminum, or polymer composites, and may be shaped in but are not limited to any combination of a straight, helical, curved, or aerofoil configuration. In one embodiment, the wind turbine 108 is a vertical-axis wind turbine allowing for omnidirectional wind capture. In another embodiment, a horizontal-axis turbine may be utilized to align with prevailing wind direction. The turbine 108 may be comprised of at least one sensor 702 to monitor wind speed, rotational speed, and system performance, and to initiate shutoff protocols of the turbine 108 during hazardous conditions.

In some embodiments, the solar panels 104 are mounted to the pole component 102 via retractable mounting assemblies 110. Each retractable mounting assembly 110 may be configured to fold, collapse, and/or retract the corresponding solar panel 104 inward toward the pole component 102. In one embodiment, the retraction mechanism 111 may include any combination of (but is not limited to) one or more actuators, hinges, pivoting arms, or telescoping supports capable of adjusting the angular position and radial extension of each solar panel 104. The assemblies 110 may allow each solar panel 104 to be deployed in an extended orientation for optimal solar exposure or retracted for wind protection. Each assembly 110 and/or mechanism 111 may be powered by a power source 113 such as but not limited to any combination of an electric motor, pneumatic cylinder, or hydraulic piston. The mounting assemblies 110 may further comprise locking mechanisms 115 to secure the solar panels 104 in either extended or retracted positions.

Retraction may be manually triggered or automatically controlled via at least one sensors 700 such as but not limited to any combination of anemometers, barometers, gyroscopic stabilizers, accelerometers, temperature sensors, or vibration detectors that are responsive to wind velocity or environmental conditions. A control module 706 may process sensor 700,702 input and actuate retraction commands to the retraction mechanism 111 based on preset thresholds, such as but not limited to sustained wind speeds above a defined value. In one embodiment, the module 706 may also consider time-of-day, seasonal weather patterns, or regional storm alerts to initiate a precautionary retraction sequence.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “solar tree device”, “tree device”, “solar device”, and “device” are interchangeable and refer to the solar tree device 100 of the present invention.

Notwithstanding the foregoing, the solar tree device 100 of the present invention can be of any suitable size and configuration as is known in the art without affecting the overall concept of the invention, provided that it accomplishes the above-stated objectives. One of ordinary skill in the art will appreciate that the solar tree device 100 as shown in FIGS. 1-6 are for illustrative purposes only, and that many other sizes and shapes of the solar tree device 100 are well within the scope of the present disclosure. Although the dimensions of the solar tree device 100 are important design parameters for user convenience, the solar tree device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar tree device comprising:
a pole component;
a wind turbine;
a first sensor; and
a plurality of solar panels secured to the pole component via a plurality of retractable mounting assemblies, wherein the plurality of solar panels are secured along a length and around a circumference of the pole component in a tree-like configuration, and further wherein the plurality of solar panels generate electricity from sunlight.

2. The solar tree device of claim 1, wherein the plurality of retractable mounting assemblies are comprised of a retraction mechanism.

3. The solar tree device of claim 1, wherein the plurality of retractable mounting assemblies allow the plurality of solar panels to fold, collapse, or retract relative to the pole component.

4. The solar tree device of claim 1, wherein the wind turbine is comprised of a second sensor.

5. The solar tree device of claim 4, wherein the second sensor is configured to measure a wind speed or a rotational speed of the wind turbine.

6. The solar tree device of claim 1, further comprised of an inverter for converting DC energy produced by the solar tree device into AC energy that is usable by conventional electric systems of a building or a power grid.

7. The solar tree device of claim 1, wherein the first sensor is comprised of an anemometer, a barometer, a gyroscopic stabilizer, an accelerometer, a temperature sensor, or a vibration detector.

8. The solar tree device of claim 6, wherein the internal cavity is used to house the at least one battery electrically connected to the plurality of solar panels, as well as the inverter for converting DC energy into AC energy.

9. The solar tree device of claim 2, further comprised of a control module.

10. The solar tree device of 9, wherein the control module actuates the retraction mechanism via an input from the first sensor or the second sensor.

11. The solar tree device of claim 9, wherein the plurality of connector components support multiple of the plurality of solar panels as a unified assembly, or each of the plurality of solar panels may be supported by a separate corresponding connector component.

12. The solar tree device of claim 10, wherein the plurality of connector components electrically connect the plurality of solar panels to the at least one battery for transferring electricity to the at least one battery.

13. The solar tree device of claim 11, wherein the plurality of connector components are secured to the pole component in a vertical configuration, thereby allowing the plurality of solar panels to be positioned upwardly, horizontal or downwardly for maximum power generation.

14. The solar tree device of claim 12, wherein the plurality of solar panels are secured in an approximately 10 to 15 degree angle relative to a sun for maximum power generation.

15. The solar tree device of claim 13, wherein a subset of the plurality of solar panels located toward a top of the pole component are smaller relative to a second subset of the plurality of solar panels located toward a bottom of the pole component, such that an overall shape of the solar tree device is generally conical; and an overall maximum length of each successive solar panel is greater than a preceding solar panel to allow each solar panel to receive light.

16. A solar tree device comprising:
a base;
a pole component secured to the base;
a wind turbine;
a plurality of solar panels secured to the pole component via a plurality of retractable mounting assemblies comprising a retraction mechanism powered by a power source, wherein the plurality of solar panels are secured along a length and around a circumference of the pole component in a tree-like configuration;
at least one battery electrically connected to at least one of the plurality of solar panels for storing electrical energy captured via the plurality of solar panels; and
an inverter for converting a DC energy produced by the solar tree device into an AC energy that is usable by a conventional electric system of a building or a power grid; and
further wherein each of the plurality of solar panels comprise a photovoltaic top surface and a heat conducting bottom surface to capture a thermal energy, or each of the plurality of solar panels comprise a photovoltaic bottom surface and a heat conducting top surface to capture the thermal energy.

17. The solar tree device of claim 15, wherein the plurality of connector components support multiple solar panels as a unified assembly, or each of the plurality of solar panel may be supported by a separate corresponding connector component.

18. The solar tree device of claim 15, further comprised of a first sensor comprised of an anemometer, a barometer, a gyroscopic stabilizer, an accelerometer, a temperature sensor, or a vibration detector.

19. The solar tree device of claim 15, wherein the plurality of solar panels comprise a light reflecting ridge and a transparent glass plate.

20. A method of generating solar power in a relatively small space, the method comprising the steps of:
providing a solar tree device comprising a pole component and a plurality of solar panels attached to the pole component via a retractable mounting assembly comprised of a retraction mechanism;
choosing a specific height and diameter of the pole component;
securing the plurality of solar panels along a length of the pole component in a conical configuration;
placing the solar tree device in a predetermined location; and
generating a solar energy.
